(19) United States
(12) Patent Application Publication
(10) Pub. No.: US 2019/0186550 A1
(43) Pub. Date: Jun. 20, 2019

(54) TOOTHED DISK COUPLING

(71) Applicant: ECYCLI LTD., Tel-Aviv (IL)

(72) Inventors: Arie BERGMAN, Tel-Aviv (IL); Kobby Greenberg, Even-Yehuda (IL); Shaul Shwartz, Even-Yehuda (IL)

(73) Assignee: ECYCLI LTD., Tel-Aviv (IL)

(21) Appl. No.: 15/847,928

(22) Filed: Dec. 20, 2017

(51) Int. Cl. F16D 11/14

(52) U.S. Cl. CPC F16D 11/14; F16D 2011/008

(57) ABSTRACT

A coupling includes a driving disk connected to a driving shaft and rotatable about a driving axis. An engagement face of the driving disk includes a predetermined number of at least three driving teeth that are distributed azimuthally on the engagement face of the driving disk along a circle concentric to the driving axis. A driven disk connected to a driven shaft and rotatable about a driven axis has an engagement face including the predetermined number of driven teeth azimuthally distributed along a circle concentric to the driven axis. At least one of the driving shaft and the driven shaft possesses translational freedom or angular freedom of motion with respect to the other so that when the driving teeth of the driving disk engage the driven teeth, the driving axis and the driven axis are self-aligned.

### FIELD OF THE INVENTION

The present invention relates to coupling. More particularly, the present invention relates to a toothed disk coupling.

### BACKGROUND OF THE INVENTION

Mechanical devices often require a transmission between a driver, which may include a motor or other device for generating a torque, and a driven component, such as a wheel of a vehicle. A coupling may connect a driving shaft of the driver with a driven shaft of the driven component. The coupling is designed to transmit the torque from the driver shaft to the driven shaft.

A coupling may be designed to accommodate misalignment between the driver shaft and the driven shaft. In some cases, the coupling may be designed to enable the driver shaft and the driven shaft to move with respect to one another when in operation.

For example, angular misalignment may occur when one of the shafts changes its orientation relative to the other. A universal joint, sometimes referred to as a Cardan joint, may be designed to accommodate such angular misalignment or motion. The universal joint typically includes a pair of axes that enable bending of one shaft with respect to the other in different directions.

Parallel misalignment may occur in which one shaft is displaced laterally with respect to the other so that the shafts remain parallel with one another but not collinear. An Oldham coupling may accommodate such parallel misalignment. An Oldham coupling typically includes a pair of grooves that enable lateral sliding of one shaft relative to the other in different lateral directions.

Axial misalignment may occur in which one shaft may be displaced relative to the other along their common axis (thus remaining both parallel and collinear). A spline may accommodate such axial misalignment. A spline typically includes elongated grooves that enable axial movement of one shaft relative to the other.

In some cases, a coupling may include a clutch mechanism to enable the driving shaft to disengage from the driven shaft, or to engage the driven shaft in order to apply torque and rotate the driven shaft.

### SUMMARY OF THE INVENTION

There is thus provided, in accordance with an embodiment of the present invention, a coupling including: a driving disk connected to a driving shaft and rotatable about a driving axis, an engagement face of the driving disk including a predetermined number of at least three driving teeth that are distributed azimuthally on the engagement face of the driving disk along a circle concentric to the driving axis; and a driven disk connected to a driven shaft and rotatable about a driven axis, an engagement face of the driven disk including the predetermined number of driven teeth azimuthally distributed on the engagement face of the driven disk along a circle concentric to the driven axis, wherein at least one of the driving shaft and the driven shaft possesses translational freedom or angular freedom of motion with respect to the other so that when the driving teeth of the driving disk engage the driven teeth, the driving axis and the driven axis are self-aligned.

Furthermore, in accordance with an embodiment of the present invention, the driving teeth are uniformly distributed along the circle concentric to the driving axis and the driven teeth are uniformly distributed on the circle concentric to the driven axis.

Furthermore, in accordance with an embodiment of the present invention, each driving tooth includes a face that is slanted at an acute angle with respect to the engagement face of the driving disk and toward a direction of rotation of the driving shaft and each driven tooth includes a face that is slanted at substantially the acute angle with respect to the engagement face of the driven disk toward a direction opposite to a direction of rotation of the driven shaft.

Furthermore, in accordance with an embodiment of the present invention, a face of each driving tooth that is opposite the face of that driving tooth that is slanted toward the direction of rotation of the driving shaft is slanted at an acute angle to the engagement face of the driving disk, and a face of each driven tooth that is opposite the face of that driven tooth that is slanted opposite the direction of rotation of the driven shaft is slanted at an acute angle to the engagement face of the driven disk.

Furthermore, in accordance with an embodiment of the present invention, an outer face of each driving tooth that is distal to the driving disk is substantially flat, and an outer face of each driven tooth that is distal to the driven disk is substantially flat.

Furthermore, in accordance with an embodiment of the present invention, the outer faces of at least three of the driving teeth are substantially coplanar and parallel to the engagement face of the driving disk or the outer faces of at least three of the driven teeth are substantially coplanar and parallel to the engagement face of the driven disk.

Furthermore, in accordance with an embodiment of the present invention, each tooth of the plurality of driving teeth and of the plurality of driven teeth is laterally rotated.

Furthermore, in accordance with an embodiment of the present invention, the driving disk is incorporated into a detachable propulsion unit.

Furthermore, in accordance with an embodiment of the present invention, the portable propulsion unit is configured to be mounted onto a chassis of a vehicle.

Furthermore, in accordance with an embodiment of the present invention, the chassis includes the driven disk, the driven disk being coupled to a propulsion wheel of the vehicle.

Furthermore, in accordance with an embodiment of the present invention, the vehicle includes a bicycle.

Furthermore, in accordance with an embodiment of the present invention, the driven disk is coupled to a chain sprocket of the bicycle.

Furthermore, in accordance with an embodiment of the present invention, the portable propulsion unit includes a motor for rotating the driving shaft.

Furthermore, in accordance with an embodiment of the present invention, the portable propulsion unit includes a transmission for transmitting torque from the motor to the driving shaft.

Furthermore, in accordance with an embodiment of the present invention, the transmission includes a belt.

There is further provided, in accordance with an embodiment of the present invention, a portable propulsion unit including: a motor; and a driving disk connected to a driving shaft that is coupled to the motor and that is rotatable about a driving axis, an engagement face of the driving disk including a predetermined number of at least three driving teeth that are distributed azimuthally on the engagement face of the driving disk along a circle concentric to the driving axis, wherein when the portable propulsion unit is mounted to a chassis of a vehicle, the chassis including a driven disk connected to a driven shaft and rotatable about a driven axis, an engagement face of the driven disk including the predetermined number of driven teeth azimuthally distributed on the engagement face of the driven disk along a circle concentric to the driven axis, the driven axis being coupled to a propulsion wheel of the vehicle, at least one of the driving shaft and the driven shaft possessing translational freedom or angular freedom of motion with respect to the other, operation of the motor causes the driving teeth of the driving disk to engage the driven teeth and causes the driving axis and the driven axis to self-align.

Furthermore, in accordance with an embodiment of the present invention, the driving teeth are uniformly distributed along the circle concentric to the driving axis.

Furthermore, in accordance with an embodiment of the present invention, each driving tooth includes a face that is slanted at an acute angle with respect to the engagement face of the driving disk and toward a direction of rotation of the driving shaft.

Furthermore, in accordance with an embodiment of the present invention, the portable propulsion unit includes a transmission for transmitting torque from the motor to the driving shaft.

Furthermore, in accordance with an embodiment of the present invention, the transmission includes a belt.

### BRIEF DESCRIPTION OF THE DRAWINGS

In order for the present invention to be better understood and for its practical applications to be appreciated, the following figures are provided and referenced hereafter. It should be noted that the Figures are given as examples only and in no way limit the scope of the invention. Like components are denoted by like reference numerals.

FIG. 1 schematically illustrates a coupling with toothed coupling disks, in accordance with an embodiment of the present invention.

FIG. 2 schematically illustrates the coupling shown in FIG. 1, with the teeth of the disks engaged.

FIG. 3 schematically illustrates structure of a tooth of a toothed coupling disk of the coupling shown in FIG. 1.

FIG. 4A schematically illustrates forces that are exerted by a driving tooth of the coupling shown in FIG. 1 on a driven tooth of the coupling when in partial contact.

FIG. 4B schematically illustrates forces that are exerted by a driving tooth of the coupling shown in FIG. 1 on a driven tooth of the coupling when one of the disks is angularly misaligned relative to the other.

FIG. 5 schematically illustrates engagement of parallelly misaligned toothed coupling disks of the coupling shown in FIG. 1.

FIG. 6 schematically illustrates a variation of the coupling shown in FIG. 5 in which the teeth are laterally rotated.

FIG. 7 schematically illustrates teeth of toothed coupling disks that are configured to apply torque in either direction of rotation.

FIG. 8 schematically illustrates a propulsion unit that includes a driving disk of the coupling shown in FIG. 1.

FIG. 9 schematically illustrates mounting the propulsion unit shown in FIG. 8 on a chassis.

FIG. 10 schematically illustrates the propulsion unit and chassis shown in FIG. 9 configured to drive a wheel.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

In accordance with an embodiment of the present invention, a coupling mechanism includes a pair of toothed disks. Each disk may be connected to a distal (e.g., from a motor or driving mechanism that drives the driving shaft, or from a mechanism that is to be operated by rotation of the driven shaft) end of a driving shaft or a driven shaft. In some cases, each shaft may be constructed as a single unit together with its toothed disk. For example, in some cases, a pulley wheel or gear on which the toothed disk is mounted, or that incorporates the toothed disk, may be configured so as to function as a driving shaft or driven shaft.

As used herein, the disk that is connected to the driving shaft is referred to as the driving disk, and teeth of the driving disk are referred to as driving teeth. The disk that is connected to the driven shaft is herein referred to as the driven disk, and teeth of the driven disk are referred to as driven teeth. When operated in a typical manner, the driving teeth of the driving disk engage the driven teeth of the driven disk. When so engaged, a torque that is applied to the driving disk may be applied via the engaged teeth to the driven disk. Furthermore, the teeth are configured such that when the driving disk and the driven disk are initially misaligned (e.g., angularly, parallelly, or axially), engagement of the teeth together with application of the torque may force the driving shaft and the driven shift into alignment.

The teeth are azimuthally distributed on the disk about a circle that is concentric to an axis of rotation of the disk. Typically, the teeth are uniformly distributed about the circumference of the disk, such that the azimuthal distance between each pair of adjacent teeth (at a given radius from the axis of the disk, e.g., on a circle that is concentric with the disk) is substantially identical for all such pairs of adjacent teeth. The number (at least three) and distribution of teeth on both disks is typically identical. In some cases, one of the disks may have more teeth than the other (e.g., where the number of uniformly distributed teeth on one of the disks is an integral multiple of the number of teeth on the other disk).

The teeth on each of the toothed disks may have at least one face that is inclined with respect to the axis of rotation of the attached shaft. For example, on the driving disk, at least a forward-facing face of each driving tooth may be inclined forward and outward. As used herein, the terms “forward” and “forward facing” refer to the direction toward which the driving disk is rotated when the driving disk is to apply torque to the driven disk. As used herein, “outward” refers to the side of one of the disks that faces toward the other disk that is to be engaged.

In some cases, the forward-facing face of a driving tooth on the driving disk may be positioned on the disk such that the forward-facing face is laterally rotated, inclined, or slanted (e.g., rotated about an axis that is parallel to the common axis of rotation of the disk and the connected shaft) relatively to a radius of the disk through the driving tooth. Thus, the face may be oriented diagonally with respect to the local radius of the disk (e.g., a radius of the disk that intersects a midpoint of the face). The lateral rotation may be such that the forward-facing face is oriented forward and proximally (e.g., toward the axis of rotation).

Typically, the driving disk and the driven disk have substantially identical disk faces and teeth. Thus, a driving shaft with a connected driving disk may be interchangeable (e.g., at least as far as the coupling between the shafts and disks, possibly not with regard to structure on the shafts that is not adjacent to the connected disk) with a driven shaft and its connected driven disk. When configured to couple between the driving disk and the driven disk, the driven disk faces in a substantially (e.g., except for any misalignment) opposite direction to the driving disk. Thus, the inclined face of each driven tooth of the driven disk may be oriented so as to be engaged by the inclined face of a driving tooth of the driving disk.

When the driving shaft is to drive the driven shaft, a torque may be applied to the driving shaft, and to the connecting driving disk, in a forward direction. For example, a motor, crank, pedal, or other mechanism may be operated to rotate the driving shaft. The forward direction may correspond to a direction in which the driven shaft is to be rotated, e.g., in order to propel a vehicle or other self-propelling device in a particular direction, in order to cause a machine or mechanism to execute a particular operation, to generate electrical power, or for another purpose.

Prior to, concurrently with, or subsequent to the beginning of the application of the torque, one or both of the driving disk and the driven disk may be moved toward the other (e.g., by releasing a clutch mechanism or activating another engagement mechanism). Typically, a disk that is moved toward the other may be moved substantially along its own axis of rotation, or along another direction. Thus, the teeth of the driving disk and of the driven disk may be brought into proximity of one another. For example, when brought into proximity, the driving teeth of the driving disk may be located within spaces between the driven teeth of the driven disk. Thus, the rotation of the driving disk may bring one or more driving teeth of the driving disk into contact with one or more driven teeth of the driven disk.

Typically, when a driving tooth of the driving disk comes into contact with a driven tooth of the driven disk, the inclined face of the driving tooth may meet or press against the inclined face of the driven tooth. A force that is applied by the inclined face of the driving tooth to the inclined face of the driven tooth may include one or more components that tend to align the driving shaft with the driven shaft.

For example, the applied force may have an axial component that pulls the driving disk and the driven disk toward one another. Thus, this component of the force may tend to correct an axial misalignment. The axial pulling force may also act to correct an angular or parallel misalignment. For example, when the driving shaft and the driven shaft are axially or parallelly misaligned, driving teeth of the driving disk may engage one or more driven teeth on one side of the driven disk before they engage driven teeth on an opposite side (e.g., an approximately diametrically opposite side) of the driven disk. The resulting imbalance in forces may tend to pull the driving disk and the driven disk, and thus the driving shaft and the driven shaft, into angular and parallel alignment. In some cases, a lateral slant of the teeth may further facilitate correction a misalignment (e.g., parallel misalignment).

Thus, the toothed coupling mechanism may enable relative motion between the driving shaft and the driven shaft. One or both of the driving shaft and the driven shaft may possess translational or angular (rotational) freedom to enable self alignment of the shafts in response to forces that are exerted by the driving teeth and the driven teeth when engaging one another. For example, the shafts and coupling mechanism may accommodate five degrees of freedom (three translational, and two rotational). The degrees of freedom may enable self-corrections of any misalignment, whether angular, parallel, or axial. Some or all of degrees of freedom may be provided by an assembly that includes one of the shafts (e.g., a motor assembly for mounting on a bicycle).

Once the driving teeth have engaged the driven teeth, forces that are applied by the inclined faces of the teeth may act to counteract any forces (e.g., caused by a vehicle encountering a bump or depression in a road, or otherwise created) that may temporarily disturb the alignment and that could otherwise cause the teeth to disengage from one another.

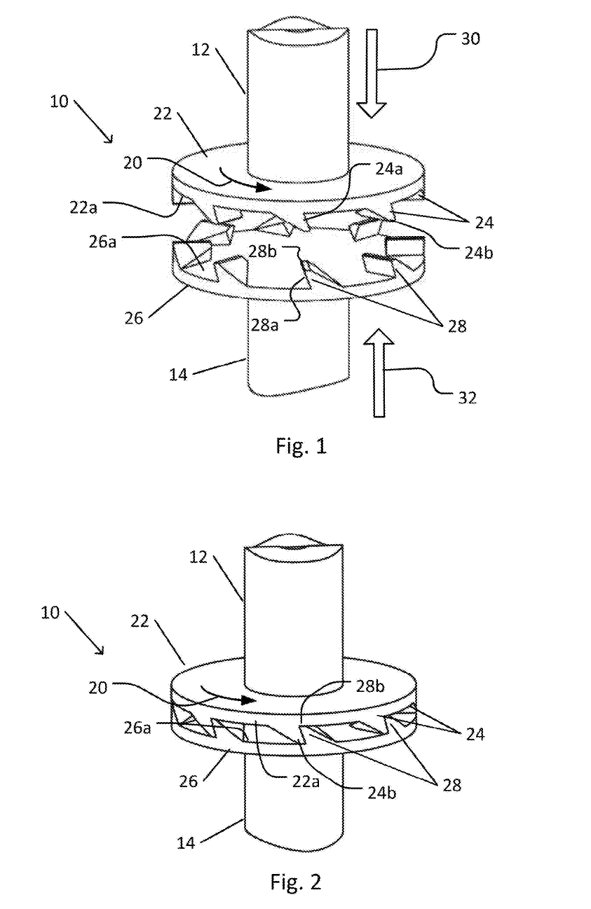

FIG. 1 schematically illustrates a coupling with toothed coupling disks, in accordance with an embodiment of the present invention.

Toothed coupling 10 is configured to enable application of a torque from driving shaft 12 to driven shaft 14. In the example shown, toothed coupling 10 is disengaged such that a torque that is applied to driving shaft 12 is not applied to driven shaft 14. In the example of toothed coupling 10 that is shown, toothed coupling 10 is configured to be engaged to enable transmission of a torque from driving shaft 12 to driven shaft 14 when the direction of the torque is as indicated by rotation direction 20. When the torque is in the direction opposite to the direction indicated by rotation direction 20, toothed coupling 10 may not transmit the torque.

Driving shaft 12 may be connected to a motor, crank, pedal, turbine, or other source of torque, either directly or via a transmission. Driving shaft 12 is connected to driving disk 22 of toothed coupling 10 such that driving disk 22 rotates together with driving shaft 12. Thus, a torque that is applied to driving shaft 12 is also applied to driving disk 22.

Engagement face 22a of driving disk 22 faces outward (e.g., distally toward driven disk 26) and includes a plurality of driving teeth 24. Forward face 24a of each driving tooth 24 is on a leading side of driving tooth 24 when driving disk 22 rotates in rotation direction 20. Forward face 24a is substantially flat and sloped forward and outward to form an acute angle with engagement face 22a of driving disk 22.

Thus, when a torque is applied to driving shaft 12 and driving disk 22 in the direction of rotation direction 20, forward face 24a may apply a pushing force to an object or surface that comes into contact with forward face 24a. The net applied force may be directed forward (e.g., toward rotation direction 20) and inward (toward the base of driving tooth 24, e.g., toward engagement face 22a).

In the example shown, the outermost (distal to driving disk 22) end of driving tooth 24 terminates in outer face 24b, which is substantially flat. In other examples, the outermost end of driving tooth 24 may form a sharp edge, may be slanted, blunted, curved, or otherwise shaped. In other examples, outer faces 24b of at least three driving teeth 24, e.g., of those driving teeth 24 whose outer faces 24b extend furthermost from engagement face 22a of driving disk 22, may be substantially coplanar in a plane that is substantially parallel to engagement face 22a Similarly, outer faces 28b of at least three of teeth 28, e.g., of those driven teeth 28 whose outer faces 28b extend furthermost from engagement face 26a of driven disk 26, may be substantially coplanar in a plane that is substantially parallel to engagement face 26a.

Driven shaft 14 may be connected to a drive wheel, to a generator, a propeller, or to another mechanism that may be operated by a torque, either directly or via a transmission. Driven shaft 14 is connected to driven disk 26 of toothed coupling 10 such that driven disk 26 rotates together with driven shaft 14. Thus, a torque that is applied to driven disk 26 is also applied to driven shaft 14.

Engagement face 26a of driven disk 26 faces outward (e.g., distally toward driving disk 22) and includes a plurality of driven teeth 28. Rearward face 28a of each driven tooth 28 is on a trailing side of driven tooth 28 when driven disk 26 is being rotated in rotation direction 20. Rearward face 28a is sloped rearward and outward to form an acute angle with engagement face 26a of driven disk 26.

Thus, when a pushing force is applied to rearward face 28a of one or more driven teeth 28 on driven disk 26 (e.g., approximately normal to rearward face 28a or approximately parallel to engagement face 26a of driven disk 26), a torque may be applied to driven disk 26 in the direction of rotation direction 20. The applied force may be decomposed into a component that is directed forward (e.g., toward rotation direction 20), and a component that is directed inward (toward the base of driven tooth 28, e.g., toward engagement face 26a).

In the example shown, the outermost (distal to driven disk 26) end of driven tooth 28 terminates in outer face 28b, which is substantially flat and parallel to engagement face 26a of driven disk 26. Outer faces 28b of all driven teeth 28 are substantially coplanar. In other examples, the outermost end of driven tooth 28 may form a sharp edge, may be slanted, blunted, or curved, or may be otherwise shaped.

Toothed coupling 10 may be engaged, when torque is applied to driving shaft 12, to rotate driving disk 22 in rotation direction 20. For example, driving disk 22 may be moved toward driven disk 26 with axial motion 30, driven disk 26 may be moved toward driving disk 22 with axial motion 32, or both driving disk 22 and driven disk 26 may be moved toward one another. When driving disk 22 and driven disk 26 are sufficiently close to one another, one or more of rotating driving teeth 24 may engage one or more of driven teeth 28. When one or more driving teeth 24 engage one or more driven teeth 28, the torque may be transmitted to driven disk 26 and to driven shaft 14.

In addition, the engagement of driven teeth 28 by driving teeth 24 may apply a force to correct one or more initial misalignments (e.g., angular, parallel, or axial) between driving shaft 12 and driven shaft 14. For example, the engagement may apply axial forces to pull driving disk 22 and driven disk 26 toward one another to eliminate axial misalignment. Initial asymmetric engagement of driven teeth 28 by driving teeth 24 may apply lateral forces (e.g., perpendicular to the axial forces) to eliminate or reduce or parallel misalignment.

FIG. 2 schematically illustrates the coupling shown in FIG. 1, with the teeth of the disks engaged.

When toothed coupling 10 is fully engaged, driving disk 22 and driven disk 26 have moved maximally toward one another. For example, the movement of driving disk 22 and driven disk 26 toward one another may be checked by contact of outer faces 28b of one or more driven teeth 28 with engagement face 22a of driving disk 22, by contact of outer faces 24b of one or more driving teeth 24 with engagement face 26a of driven disk 26, or both (as in the example shown).

When toothed coupling 10 is fully engaged, the forces that corrected any initial misalignment may continue to hold driving disk 22 and driven disk 26 together. Thus, driving disk 22 and driven shaft 14, as well as driving shaft 12 and driven shaft 14, may rotate together with a common angular velocity in rotation direction 20.

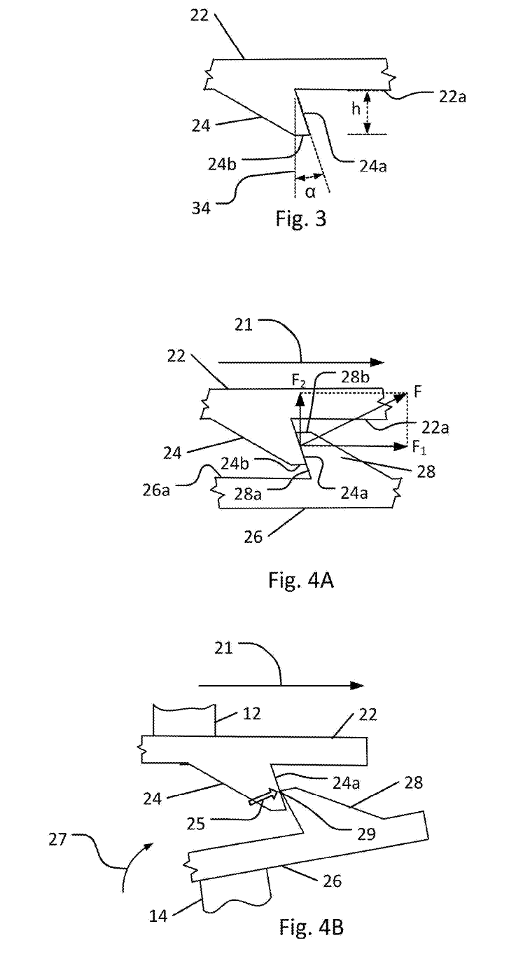

FIG. 3 schematically illustrates structure of a tooth of a toothed coupling disk of the coupling shown in FIG. 1.

In the example shown, the tooth and the coupling disk are indicated to be a driving tooth 24 and a driving disk 22, respectively. However, FIG. 3 could equally apply to a driven tooth 28 and a driven disk 26, respectively. Typically, driven teeth 28 are identical to driving teeth 24, and driven disk 26 is identical to driving disk 22.

Outer face 24b of each driving tooth 24 extends a distance h outward from the base of driving tooth 24 at engagement face 22a of driving disk 22. In the example shown, outer face 24b of driving tooth 24 is parallel to engagement face 22a. When driven disk 26 and an identical driving disk 22 are moved toward one another, one or more driving disk 22 may engage one or more driven teeth 28 when the separation distance between engagement face 22a of driving disk 22 and engagement face 26a of driven disk 26 is less than 2 h. When toothed coupling 10 is fully engaged (as in FIG. 2), the separation distance between engagement face 22a of driving disk 22 and engagement face 26a of driven disk 26 may be equal to h.

Forward face 24a of driving tooth 24 is sloped forward, such that the angle formed between forward face 24a and engagement face 22a of driving disk 22 is an acute angle. The slope of forward face 24a may be characterized by slope angle α between forward face 24a and normal 34 to engagement face 22a of driving disk 22 (and complementary to the acute angle between forward face 24a and engagement face 22a). Slope angle α and height h may be selected in accordance with an anticipated application of toothed coupling 10.

Typically, all driving teeth 24 are identical to one another (e.g., at least with regard to height h and slope angle α) Similarly, all driven teeth 28 are identical to one another and to driving teeth 24.

FIG. 4A schematically illustrates forces that are exerted by a driving tooth of the coupling shown in FIG. 1 on a driven tooth of the coupling when in partial contact.

In the example shown, driving disk 22 is rotating in rotation direction 20 such that driving tooth 24 is moving (locally) in forward direction 21. An outer region of forward face 24a of driving tooth 24 is in contact with a similar region of rearward face 28a of driven tooth 28. In the example shown, rearward face 28a of driven tooth 28 is parallel to forward face 24a of driving tooth 24. Therefore, at the region of contact, forward face 24a exerts a normal force F on rearward face 28a Similarly (as a consequence of Newton's third law of motion), rearward face 28a exerts a normal force that is equal and opposite to normal force F on forward face 24a.

Normal force F may be decomposed into a parallel component F₁ that is parallel to both engagement face 26a of driven tooth 28 and engagement face 22a of driving disk 22, and a perpendicular component F₂ that is perpendicular to outward faces 22a and 26a (and parallel to normal 34). In the example shown, F₁=F·cos (α) and F₂=F·sin (α).

Parallel component F₁ may impel driven tooth 28 to move together with driving tooth 24 in forward direction 21. Thus, parallel component F₁ may drive driven disk 26 and driven shaft 14 in rotation direction 20.

Perpendicular component F₂ impels driven tooth 28 and driven disk 26 toward engagement face 22a of driving disk 22. Thus, perpendicular component F₂ may drive driving disk 22 and driven disk 26 toward one another, e.g., to correct or prevent axial misalignment. Driving disk 22 and driven disk 26 may continue to move toward one another until contact between outer face 24b of driving tooth 24 and engagement face 26a of driven disk 26 (as well as between outer face 28b and engagement face 22a) applies a force that is equal and opposite to perpendicular component F₂. At that point, toothed coupling 10 may be fully engaged.

When toothed coupling 10 is fully engaged, continued exertion of perpendicular component F₂ may maintain the full engagement.

FIG. 4B schematically illustrates forces that are exerted by a driving tooth of the coupling shown in FIG. 1 on a driven tooth of the coupling when one of the disks is angularly misaligned relative to the other.

In the example shown, driven disk 26 is tilted relative to driving disk 22, e.g., due to an initial angular misalignment between driving shaft 12 and driven shaft 14. The region of driving disk 22 and driven disk 26 shown in FIG. 4B is an end where, as a result of the angular misalignment, driving disk 22 and driven disk 26 are closest to one another. Thus, at that region, a driving tooth 24 may contact a driven tooth 28 before such contact is made at another region of driving disk 22 or of driven disk 26.

Thus, when driving tooth 24 is impelled in forward direction 21, forward face 24a may exert a force 25 on driven tooth 28 at contact region 29 (e.g., a line of contact in three dimensions). Exertion of force 25 at one or more contact regions 29 may impel driven teeth 28 toward driving disk 22 (by perpendicular component F₂, as described above) and apply a net torque 27 to driven disk 26 and to driven shaft 14. Impelling driven teeth 28 toward driving disk 22 may result in contact between outer faces 28b of driven teeth 28 and engagement face 22a of driving disk 22 (and between outer faces 24b of driving teeth 24 and engagement face 26a of driven disk 26), forcing driven shaft 14 into alignment with driving shaft 12. Thus, toothed coupling 10 may operate to self-correct an angular misalignment.

Toothed coupling 10 may enable self correction of parallel misalignment.

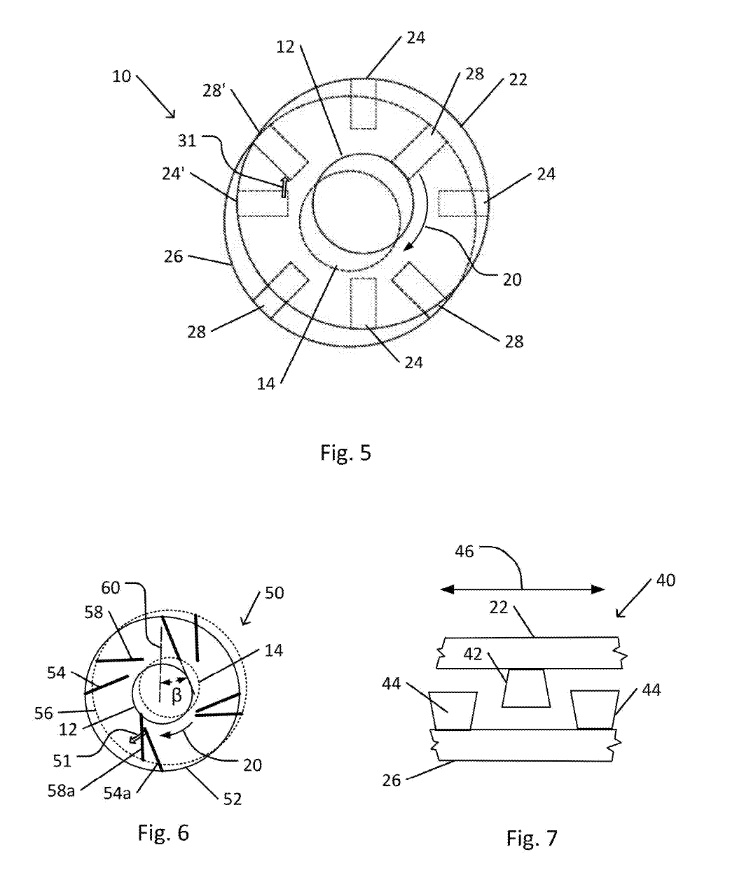

FIG. 5 schematically illustrates engagement of parallelly misaligned toothed coupling disks of the coupling shown in FIG. 1.

In the example shown, driven shaft 14 is parallel to, but laterally displaced from, driving shaft 12. Driving shaft 12 and, thus, driving disk 22 are being rotated in rotation direction 20. As driving disk 22 and driven disk 26 are moved closer to one another along the axes (perpendicular to the plane of FIG. 5) of driving shaft 12 and driven shaft 14, respectively, one of driving teeth 24, designated driving tooth 24′, may contact one of driven teeth 28, designated driven tooth 28′, before other driving teeth 24 contact other driven teeth 28. In the initial contact between driving tooth 24′ and driven tooth 28′, driving tooth 24′ may apply a contact force 31 to driven tooth 28′. Contact force 31 may be transmitted to the remainder to driven disk 26 and to driven shaft 14 to laterally push driven shaft 14 toward parallel alignment with driving shaft 12.

In some cases, teeth on each disk of a toothed coupling may be laterally rotated or slanted relative to a radius of the disk. The lateral slanting may assist in correction of misalignment.

FIG. 6 schematically illustrates a variation of the coupling shown in FIG. 5 in which the teeth are laterally rotated.

In toothed coupling 50, driving teeth 54 on driving disk 52 are laterally slanted (each driving tooth 54 represented schematically by a line indicating the forward face of the driving tooth 54). The lateral slant may be characterized by nonzero slant angle (3 (e.g., a rotation angle) relative to local radius 60 of driving disk 52. The lateral slant of each driving tooth 54 the may be forward and inward (e.g., toward the axis of rotation of driving disk 52) from a part of driving tooth that is closest to the circumference of driving disk 52 (e.g., when driving disk 52 is rotated in rotation direction 20). Driven teeth 58 on driven disk 56 are similarly laterally rotated (with the lateral rotation being rearward and inward, each driven tooth 58 being represented schematically by a line indicating the rearward face of the driven tooth 58).

In the example shown, driving shaft 12 and, thus, driving disk 52 are being rotated in rotation direction 20. As driving disk 52 and driven disk 56 are moved closer to one another along the axes (perpendicular to the plane of FIG. 6) of driving shaft 12 and driven shaft 14, respectively, one of driving teeth 54, designated driving tooth 54a, may contact one of driven teeth 58, designated driven tooth 58a, before other driving teeth 54 contact other driven teeth 58. In the initial contact between driving tooth 54a and driven tooth 58a, driving tooth 54a may apply a contact force 51 to driven tooth 58a. Contact force 51 may be transmitted to the remainder to driven disk 56 and to driven shaft 14 as a parallel alignment force in order to laterally push driven shaft 14 toward parallel alignment with driving shaft 15. The lateral slant of driving tooth 54a and of driven tooth 58a may enable contact force 51 to have larger parallel alignment component than it would have in the absence of the lateral slant (e.g., relative to the situation shown in FIG. 5).

Use of toothed coupling 10 (or of toothed coupling 50) may be advantageous in a situation where a driving shaft (e.g., of a motor) is to couple to a driven device (e.g., a wheel) where initial alignment may be expected to be imperfect, or where alignment may be disturbed.

For example, toothed coupling 10 may be applied to a removable motor of a motorized bicycle. In this case, the motor may be removed from the bicycle when the bicycle is parked, e.g., to prevent the motor from being stolen. In another scenario, the motor may be privately owned by each user of a bicycle (e.g., of a pool of bicycles) while the bicycle is provided for public use. In these situations, the motor may be replaced onto the bicycle by a user with minimal technical training. In addition, as the bicycle is being powered by the motor, various forced (e.g., centrifugal during turning, or bumps or ruts that are traversed by the bicycle) may tend to knock the motor out of alignment with the bicycle drive system. Therefore, if a drive shaft of the bicycle (e.g., a shaft replacing the usual pedal-operated crank of the bicycle) and the motor are provided with toothed coupling 10, the motor shaft may remain aligned with the drive shaft.

In many applications, such as in the case of a motorized bicycle, a driving shaft 12 may be required to apply torque to a driven shaft 14 in only one direction of rotation. For example, a motor may be expected to drive a motorized bicycle in a forward direction only, and not in reverse. In other applications, a driving shaft 12 may be required to reversible drive a driven shaft 14.

FIG. 7 schematically illustrates teeth of toothed coupling disks that are configured to apply torque in either direction of rotation.

In toothed coupling 40, driving disk 22 is provided with doubly-sloped driving teeth 42 (only one is shown). Similarly, driven disk 26 is provided with doubly-sloped driven teeth 44. In the example shown, the sloped faces on opposite sides of each doubly-sloped driving tooth 42 are identical. Also in the example shown, the sloped faces on opposite sides of each doubly-sloped driven tooth 44 are identical to one another and to the sloped faces of each doubly-sloped driving tooth 42. Thus, each doubly-sloped driving tooth 42 and doubly-sloped driven tooth 44 may have an azimuthal profile (e.g., as viewed along a radius of driving disk 22 or of driven disk 26 through the tooth) in the form of an inverted wedge or trapezoid. In some cases, the slopes on opposite faces of the doubly-sloped teeth may be different from one another (e.g., as designed for application where coupling in one direction of rotation is expected to behave differently from coupling in the other direction).

Thus, when driving disk 22 is rotated to move doubly sloped driving tooth 42 in either direction indicated by double-headed arrow 46, driving tooth 42 may contact, and apply aligning forces to, one of doubly sloped driven teeth 44 on driven disk 26. Thus, driving disk 22 may engage and self-align with driven disk 26 regardless of the direction of rotation of driving disk 22.

When the teeth are provided with a lateral slant, the teeth may have a lateral profile, e.g., when viewed along an axial direction, that is similarly wedge-shaped or trapezoidal.

A method for using toothed coupling 10 may include placing driving shaft 12 and driven shaft 14 in approximate alignment, e.g., as shown in FIG. 1. The end of driving shaft 12 that is provided with driving disk 22 faces driven shaft 14. Similarly, the end of driven shaft 14 that is provided with driven disk 26 faces driving shaft 12. Thus, when in the approximate alignment, driving teeth 24 on driving disk 22 face driven teeth 28 on driven disk 26.

Driving disk 22 and driven disk 26 may be brought toward one another, e.g., by moving driving disk 22 with axial motion 30, driven disk 26 with axial motion 32, or by moving both with both axial motions.

Prior to, subsequent to, or concurrently with the movement of driving disk 22 and driven disk 26 toward one another, driving shaft 12 and driving disk 22 may be rotated in rotation direction 20.

The rotation of driving disk 22 together with motion toward one another of driving disk 22 and driven disk 26 may cause one or more driving teeth 24 to contact one or more driven teeth 28. As a result of continued rotation of driving disk 22, mutual forces that are applied by the contacting driving teeth 24 and driven teeth 28 may continue to pull driving disk 22 and driven disk 26 toward one another, correcting any initial axial misalignment. Concurrently, the mutually applied forces may cause driving shaft 12 and driven shaft 14 to align with one another, thus correcting any initial angular or parallel misalignment.

When all initial misalignments are corrected, driving disk 22 and driven disk 26 may be fully engaged. When fully engaged, torque and rotational power that are applied to driving shaft 12 may be transmitted to driven shaft 14.

Continued application of torque to driving shaft 12 may, via application of the mutual forces between driving teeth 24 and driven teeth 28, maintain engagement and alignment between driving disk 22 and driven disk 26, and thus between driving shaft 12 and driven disk 14.

A toothed coupling as described above may be incorporated into a propulsion system, e.g., of a bicycle or other vehicle. For example, the propulsion system may include a portable propulsion unit that may be attached to or detached from a chassis of the vehicle. The detachable propulsion unit may include a motor, and a driving shaft and driving disk of the coupling. In some cases, the propulsion unit may include a transmission for transmitting a torque from the motor to the driving shaft. The chassis may include the driven disk of the coupling. When attached to the chassis and operating, the motor of the propulsion unit may drive a wheel of the vehicle.

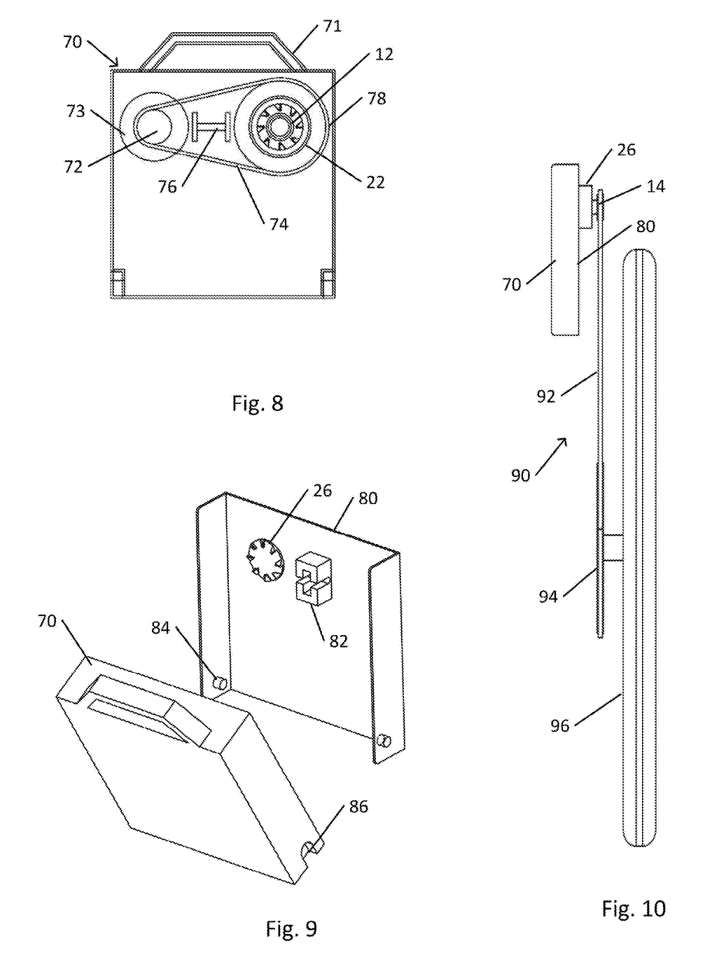

FIG. 8 schematically illustrates a propulsion unit that includes a driving disk of the coupling shown in FIG. 1. FIG. 9 schematically illustrates mounting the propulsion unit shown in FIG. 8 on a chassis.

Propulsion unit 70 may be provided with unit handle 71 to facilitate portability of propulsion unit 70. In the example shown, driving disk 22 is mounted on driving disk pulley 78, both rotating about driving shaft 12. Motor pulley 72 may be rotated by motor 73 to which driving disk pulley 78 is coupled. For example, motor pulley 72 may be mounted to a rotatable shaft of motor 73, or may be rotated by torque that is applied by motor 73 via a transmission. In the example shown, rotation of motor pulley 72 may drive rotation of driving disk pulley 78 via a transmission 74 in the form of a pulley belt or other driving belt. In the example shown, the diameter of driving disk pulley 78 is larger than that of motor pulley 72. In other examples, another transmission mechanism may be provided to enable motor 73 to drive driving disk pulley 78.

Propulsion unit 70 may be mounted onto chassis 80. For example, chassis 80 may represent a bracket or other structure that is mounted onto, or incorporated into, a chassis or body of a vehicle. In the example shown, grooves 86 on propulsion unit 70 may engage pins 84 on chassis 80. Rotation of propulsion unit 70 toward chassis 80 may cause lock bar 76 of propulsion unit 70 to engage lock mechanism 82 on chassis 80. Thus, propulsion unit 70 may be secured to chassis 80. Alternatively, or in addition, other securing or locking mechanisms may be provided (e.g., one or more latches, bolts, screws, or other securing mechanisms).

When propulsion unit 70 is mounted onto chassis 80, driven disk 26 on chassis 80 may be initially misaligned with driving disk 22 on propulsion unit 70. Operation of the motor to rotate driving disk 22 may cause driving disk 22 to engage driven disk 26, causing driving disk 22 and driven disk 26 to self-align, as described above. For example, one or both of driving disk 22 and driven disk 26 may include an axle or shaft with a section that is at least partially flexible. Alternatively, or in addition, other mechanisms may be provided to enable limited translational or rotational freedom of movement. One or more of grooves 86, pins 84, lock mechanism 82, and lock bar 76 may be configured to enable at least minimal freedom of movement such that driving disk 22 and driven disk 26 may self-align.

FIG. 10 schematically illustrates the propulsion unit and chassis shown in FIG. 9 configured to drive a wheel.

For example, vehicle 90 may represent a bicycle or other type of vehicle. Driven shaft 14 may be coupled to propulsion wheel 96 of the vehicle such that when torque is applied to driven shaft 14 via driving disk 22 and driven disk 26, torque is applied to propulsion wheel 96, e.g., to propel the vehicle. Alternatively, or in addition, torque that is applied to driven shaft 14 may rotate or drive another component of the vehicle, or of another type of machine, device, or mechanism.

In the example shown, driven shaft 14 functions as a drive pulley or drive sprocket of vehicle 90. Driven shaft 14 is configured to operate transmission 92 when rotated. For example, transmission 92 may represent a bicycle chain or a pulley belt. Operation of transmission 92 may cause drive wheel 94 (e.g., a pulley wheel or a chain sprocket) to rotate, which in turn may cause propulsion wheel 96 to rotate, thus propelling a vehicle on which propulsion wheel 96 is mounted.

Different embodiments are disclosed herein. Features of certain embodiments may be combined with features of other embodiments; thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A coupling comprising:
a driving disk connected to a driving shaft and rotatable about a driving axis, an engagement face of the driving disk including a predetermined number of at least three driving teeth that are distributed azimuthally on the engagement face of the driving disk along a circle concentric to the driving axis; and
a driven disk connected to a driven shaft and rotatable about a driven axis, an engagement face of the driven disk including said predetermined number of driven teeth azimuthally distributed on the engagement face of the driven disk along a circle concentric to the driven axis,
wherein at least one of the driving shaft and the driven shaft possesses translational freedom or angular freedom of motion with respect to the other so that when the driving teeth of the driving disk engage the driven teeth, the driving axis and the driven axis are self-aligned.

2. The coupling of claim 1, wherein the driving teeth are uniformly distributed along the circle concentric to the driving axis, and wherein the driven teeth are uniformly distributed on the circle concentric to the driven axis.

3. The coupling of claim 1, wherein each driving tooth includes a face that is slanted at an acute angle with respect to the engagement face of the driving disk and toward a direction of rotation of the driving shaft, and wherein each driven tooth includes a face that is slanted at substantially the acute angle with respect to the engagement face of the driven disk toward a direction opposite to a direction of rotation of the driven shaft.

4. The coupling of claim 3, wherein a face of each driving tooth that is opposite the face of that driving tooth that is slanted toward the direction of rotation of the driving shaft is slanted at an acute angle to the engagement face of the driving disk, and wherein a face of each driven tooth that is opposite the face of that driven tooth that is slanted opposite the direction of rotation of the driven shaft is slanted at an acute angle to the engagement face of the driven disk.

5. The coupling of claim 1, wherein an outer face of each driving tooth that is distal to the driving disk is substantially flat, and wherein an outer face of each driven tooth that is distal to the driven disk is substantially flat.

6. The coupling of claim 5, wherein the outer faces of at least three of the driving teeth are substantially coplanar and parallel to the engagement face of the driving disk or the outer faces of at least three of the driven teeth are substantially coplanar and parallel to the engagement face of the driven disk.

7. The coupling of claim 1, wherein each tooth of said plurality of driving teeth and of said plurality of driven teeth is laterally rotated.

8. The coupling of claim 1, wherein the driving disk is incorporated into a detachable propulsion unit.

9. The coupling of claim 8, wherein the portable propulsion unit is configured to be mounted onto a chassis of a vehicle.

10. The coupling of claim 8, wherein the chassis includes the driven disk, the driven disk being coupled to a propulsion wheel of the vehicle.

11. The propulsion unit of claim 9, wherein the vehicle comprises a bicycle.

12. The propulsion unit of claim 11, wherein the driven disk is coupled to a chain sprocket or pulley belt of the bicycle.

13. The coupling of claim 8, wherein the portable propulsion unit comprises a motor for rotating the driving shaft.

14. The coupling of claim 13, wherein the portable propulsion unit comprises a transmission for transmitting torque from the motor to the driving shaft.

15. The coupling of claim 14, wherein the transmission comprises a belt.

16. A portable propulsion unit comprising:
a motor; and
a driving disk connected to a driving shaft that is coupled to the motor and that is rotatable about a driving axis, an engagement face of the driving disk including a predetermined number of at least three driving teeth that are distributed azimuthally on the engagement face of the driving disk along a circle concentric to the driving axis,
wherein, when the portable propulsion unit is mounted to a chassis of a vehicle, the chassis including a driven disk connected to a driven shaft and rotatable about a driven axis, an engagement face of the driven disk including said predetermined number of driven teeth azimuthally distributed on the engagement face of the driven disk along a circle concentric to the driven axis, the driven axis being coupled to a propulsion wheel of the vehicle, at least one of the driving shaft and the driven shaft possessing translational freedom or angular freedom of motion with respect to the other, operation of the motor causes the driving teeth of the driving disk to engage the driven teeth and causes the driving axis and the driven axis to self-align.

17. The portable propulsion unit of claim 16, wherein the driving teeth are uniformly distributed along the circle concentric to the driving axis.

18. The portable propulsion unit of claim 16, wherein each driving tooth includes a face that is slanted at an acute angle with respect to the engagement face of the driving disk and toward a direction of rotation of the driving shaft.

19. The portable propulsion unit of claim 16, further comprising a transmission for transmitting torque from the motor to the driving shaft.

20. The portable propulsion unit of claim 16, wherein the transmission comprises a belt.
